(19) United States
(12) Patent Application Publication
(10) Pub. No.: US 2006/0251850 A1
(43) Pub. Date: Nov. 9, 2006

(54) Optical disc, information reproducing method, and information recording method

(76) Inventors: Yasuaki Ootera, Kawasaki-shi (JP); Kazuyo Umezawa, Yokohama-shi (JP); Nobuhisa Yoshida, Kamakura-shi (JP); Naomasa Nakamura, Yokohama-shi (JP); Koji Takazawa, Tokyo (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 11/418,300

(22) Filed: May 5, 2006

(30) Foreign Application Priority Data
May 6, 2005 (JP) 2005-135227

(51) Int. Cl. B32B 3/02

(52) U.S. Cl. 428/64.4

(57) ABSTRACT

An optical disc comprising three or more of a predetermined number of information recording layers between a first molding disc and a second molding disc, each of which has an incident face, is featured in that a distance between the incident face and each of the information recording layers is within the range of 600±55 μm.

### CROSS-REFERENCE TO RELATED APPLICATIONS

This application is based upon and claims the benefit of priority from Japanese Patent Application No. 2005-135227, filed May 6, 2005, the entire contents of which are incorporated herein by reference.

### BACKGROUND

1. Field

The present invention relates to an optical disc; and an information reproducing method for reproducing information recorded in the optical disc; and an information recording method for recording information in the optical disc.

2. Description of the Related Art

Currently, optical disc s such as a compact disc (CD) and a digital versatile disc (DVD) are generally used as mediums for storing digitized information. Among them, the DVD (or HD DVD whose standardization is promoted as an optical disc of a next generation) enables large capacitance caused by double layering of an information recording layer comparatively easily because of a disc structure of bonding two plastic substrates (Jpn. Pat. Appln. KOKAI Publication No. 9-212917).

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

The file of this patent contains at least one photograph executed in color. Copies of this patent with color photograph will be provided by the Patent and Trademark Office upon request and payment of the necessary fee.

FIG. 1 is a sectional view showing a construction of an optical disc according to an embodiment of the present invention;

FIG. 2A, FIG. 2B, and FIG. 2C are views, each of which shows an image indicating a reproducing signal waveform from a first information recording layer and a second information recording layer of the optical disc;

FIG. 3A, FIG. 3B, FIG. 3C, FIG. 3D, FIG. 3E, FIG. 3F, FIG. 3G, FIG. 3H, FIG. 3I, FIG. 3J, FIG. 3K, FIG. 3L, and FIG. 3M are views each showing a method of manufacturing the optical disc according to an embodiment of the present invention;

FIG. 4A and FIG. 4B are views showing an image indicating an irregular pattern formed in a second intermediate layer formed in accordance with viscosity obtained before hardening a photo polymer;

FIG. 5 is a view showing a configuration of an optical disc reproducing/recording apparatus according to an embodiment of the present invention;

FIG. 6 is a view showing a configuration of a modified example of the optical disc according to an embodiment of the present invention;

FIG. 7A, FIG. 7B, FIG. 7C, and FIG. 7D are views, each of which shows a modified example of a method for manufacturing the optical disc according to an embodiment of the present invention; and

FIG. 8A, FIG. 8B, FIG. 8C, FIG. 8D, and FIG. 8E are views, each of which shows a modified example of a method for manufacturing the optical disc according to an embodiment of the present invention.

### DETAILED DESCRIPTION

Various embodiments according to the invention will be described hereinafter with reference to the accompanying drawings. In general, according to one embodiment of the invention, an optical disc comprises, a first molding disc having an incident face, a second molding disc arranged to face the first molding disc, and three or more of a predetermined number of information recording layers between the first molding disc and the second molding disc, a distance provided between the incident face and each of the information recording layers is within the range of 600±55 μm.

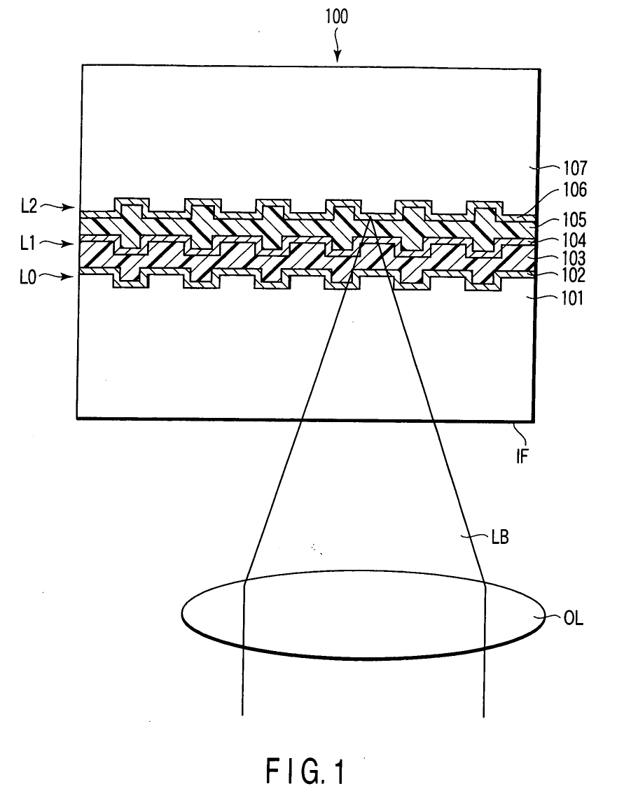

FIG. 1 is a view showing a configuration of a reproduction only single-sided three-layered optical disc according to an embodiment of the present invention.

An optical disc 100 is formed in a doughnut shape, and its dimensions have an outer diameter of 120 mm, an inner diameter of 15 mm, total thickness of 1.2 mm±0.03 mm, which are equal to those of a CD or a DVD (or HD DVD and Blue-ray Disc).

As shown in FIG. 1, the optical disc 100 has a first molding disc 101 made of polycarbonate on an incident face (IF) of a laser light beam LB irradiated from an optical system OL. A first pit (irregular pattern) indicating information is provided on a face opposite to the incident face (IF) of the first molding disc 101. The first pit is 0.204 μm in the shortest length, and is formed in a spiral shape at track pitched of 0.40 μm. The first molding disc 101 has translucency with respect to the wavelength of a laser light beam LB. A first semitransparent film 102 is provided on a surface of the first molding disc 101 opposite to the incident face IF. A first information recording layer L0 is composed of the first pit and the first semitransparent film 102.

A first intermediate layer 103 is provided on the first semitransparent film 102. A second pit (irregular pattern) indicating information is provided on a surface of the first intermediate layer 103 opposite to the incident face IF. A second semitransparent film 104 made of a metal is provided on a face having the second pit of the first intermediate layer 103 formed thereon. A second information recording layer L1 is composed of the second pit and the second semitransparent film 104.

A second intermediate layer 105 is provided on the second semitransparent layer 104. A reflection film 106 composed of a metal is provided on the second intermediate layer 105. A second molding disc 107 made of polycarbonate is provided on the reflection film 106. Third pit (irregular pattern) indicating information is provided on a surface of the second molding disc 107 at an incident face IL side. A third information recording layer L2 is composed of the third pit and the reflection film 106.

The intermediate layers 103, 105 are formed between a pair of information recording layers adjacent to each other in a thickness direction of the optical disc 100, i.e., between the first information recording layer L0 and the second information recording layer L1 and between the second information recording layer L1 and the third information recording layer L2.

The first pit, the second pit, and the third pit are 0.204 μm in the shortest length, and are formed in a spiral shape at track pitches of 0.40 μm.

Information is recorded from an inner periphery side to an outer periphery side in the first information recording layer L0. In addition, information is recorded from an outer periphery side to an inner periphery side on the second information recording layer L1. Information is recorded from an inner periphery side to an outer periphery side in the third information recording layer L2. Thus, an information recording direction is changed for each information recording layer, whereby the first information layer L1 to the third information recording layer L2 can be continuously reproduced (recorded) while an optical disc is rotated in the same direction at the time of reproduction (recording). In all of the information recording layers, information may be recorded from an inner periphery side to an outer periphery side.

For example, the information recorded in each of the information recording layers L0 to L2 of this optical disc 100 is reproduced by using an optical system OL with a reproduction light beam having a wavelength of 405 nm and NA=0.65. The laser light beams irradiated on an irradiation face IF of the optical disc 100 from a single light source incident from the incident face IF are focused on any of the information recording layers L0 to L2 by means of the optical system OL, thereby making it possible to reproduce the information recorded in the focused information recording layer.

The optical disc 100 may have four or more layered information recording layers without being limited to the above-described embodiment. In addition, this optical disc may be a write-once type optical disc using an organic dye or a rewritable type optical disc using an inorganic recording layer (phase change film). In the case of the write-once type optical disc or the inorganic recording film, a spirally shaped groove is provided on the first molding disc 101, the first intermediate layer 103, and the second molding disc 107, whereby an irregular pattern is formed. The groove wobbles in a sine wave shape in a radial direction at a predetermined period (groove wobbling). A timing clock at the time of data writing is generated based on a signal (wobble signal) produced from the groove wobbling. In addition, a protrusive portion between grooves is called a land. In the case of the rewritable optical disc using a Ge—Sb—Te based phase change film, information is recorded in a phase change film on the groove and land.

In addition, an optical system such as a DVD or a Blue-ray Disc may be used. In addition, a pattern having higher density or lower density may be used or a small diameter disc having an outer diameter of 80 mm may be used.

The optical disc 100 shown in FIG. 1 focuses a laser light beam incident from an incident face on any of the information recording layers L0 to L2, thereby making it possible to reproduce information recorded in the focused information recording layer. Factors for deteriorating a recording/reproducing signal from an information recording layer at the time of reproduction include: 1) a shift between an optimal optical position and a position of the information recording layer; 2) an inter-layered cross talk between layers; and 3) signal intensity from each layer or the like.

Now, a description will be given with respect to a disc configuration capable of restricting these deterioration factors.

First, a description will be given with respect to a shift between an optimal optical position and a position of an information recording layer. The optical system OL of the optical disc 100 according to the present embodiment is designed so as to be optimal in reproducing information recording layer over the first molding disc 101 having thickness of about 0.60 mm. If the positions of the information recording layers L0 to L2 are shifted from this optical position (0.60 mm from incident face IF), a spherical aberration occurs, and a beam spot is distorted to be great. Thus, a recording/reproducing signal deteriorates. At this time, a shift from a permissible optimal distance is ±30 μm as a result of simulation. Namely, in a single-sided three-layer disc according to the present embodiment, with respect to the positions of the first to third information recording layers L0 to L2, it is found necessary for a distance from an irradiation face IL to be within the range of 600 μm±30 μm.

However, in the case where spherical aberration correction has been applied to the optical system OL, it is possible to further widen this permissible distance to ±25 μm. Therefore, in the case where spherical aberration correction has been applied to the optical system OL, in each information recording layer of a multi-layered optical disc as shown in FIG. 1, a distance from the incident face IF may be within the range of 600 μm±55 μm. In the case of an optical system OL to which no spherical aberration correction is applied, it is desirable that the above distance be within the range of 600 μm±30 μm, as described above. When the distance is within the range of 600 μm±30 μm, even if a special spherical aberration correction mechanism is not applied to the optical system OL, a recording/reproducing signal of a desired quality can be obtained.

Now, an inter-layer cross talk will be described here. It is necessary to sufficiently take thickness of an intermediate layer in order to restrict the inter-layer cross talk. With respect to the thickness of this intermediate layer, it is obvious that its upper limit value is limited due to a shift between the above-described minimum optical position and information recording layer position. In order to check a lower limit, a signal quality check was made by actually producing an optical disc.

Testing was carried out by producing a single-sided three-layered (15 GB/layer) optical disc. The film thickness of the second intermediate layer 105 between the second information recording layer L1 and the third information recording layer L2 was changed to 15 μm, 19 μm, and 23 μm by fixing to 20 μm the film thickness of the first intermediate layer 103 between the first information recording layer L0 and the second information recording layer L1. Measurement was carried out with respect to what digits an error rate in the case of reproducing the second information recording layer L1 and the third information recording layer L2 having changed the film thickness of the second intermediate layer 105 deteriorates with respect to an error rate of a single layered disc (namely, deterioration due to an inter-layer cross talk). Further, from this deterioration rate, an error rate was calculated with respect to the second information recording layer L1 and the third information recording layer L2 required to restrict an error rate at the time of three layers to 5.0×10⁻⁵ or less that is a standard value of an HD DVD. These results were shown in Table 1. The error rate used here denotes a simulated bit error rate (SbER) defined in the HD DVD standard.

TABLE 1

| | Second intermediate layer thickness | | |
|---|---|---|---|
| | 15 μm | 19 μm | 23 μm |
| Second information | 2.98 × E−09 | 1.2 × E−07 | 1.5 × E−05 |
| recording layer | | | |
| Third information | 9.33 × E−11 | 1.2 × E−10 | 7.4 × E−08 |
| recording layer | | | |

From Table 1, if the film thickness of the second intermediate layer 105 is 23 μm, it is necessary to restrict to an order of −8 an error rate of a reproducing signal of the third information recording layer L2 that is the most distant from the incident face IF. In addition, when the thickness of the second intermediate layer 105 is only 15 μm, it is found that an error rate in a single layer must be equal to or smaller than an order of −10.

Currently, it is possible to restrict to an error rate of an order of −8 by using a laser beam recorder (LBR) presumed in an HD DVD for master disc exposure. In addition, it is possible to restrict to an error rate of an order of −10 by using a next generation exposure mechanism (such as EBR: Electron Beam Recorder or PTM: Phase Transfer Mastering). Therefore, it is found that the lower limit of an intermediate layer is 15 μm, and it is found that the lower limit is further desirably 23 μm, which can produce a disc master disc by using a current exposure mechanism. Comprehensively, it is found necessary for the thickness of an intermediate layer to be within the range of 15 μm to 55 μm (more desirably, 23 μm to 30 μm).

The signal intensity of 3) needs to be such signal intensity as to sufficiently obtain an S/N ratio and needs to obtain a signal intensity balance from each information recording layer. Further, a material used for a reflection film needs to be high in reflectance and transmission factor and not to be too small in film thickness with respect to a semitransparent film such as the first semitransparent film 102 and the second semitransparent film 104. If the film thickness of the semitransparent film or reflection film that configures an information recording layer is too small, it is difficult to stably form a film, and the film becomes weak with respect to an environmental test. Conversely, with respect to the deepest layer, it is desirable to use a material capable of obtaining a high reflectance with small film thickness. This is because, if a film is formed to be thick on a pit, a pit pattern is embedded, and a reproducing signal deteriorates.

From the foregoing, it is preferable to use silver or a silver alloy (for example, alloy of sliver and bismuth, copper, palladium, and nitrogen) with respect to a semitransparent film such as the first information recording layer L0 or the second information recording layer L2. In addition, it is preferable that the thickness of the first semitransparent film 102 be within the range of 7 nm to 15 nm. Further, it is preferable that the film thickness of the second semitransparent film 104 be within the range of 13 nm to 22 nm.

In addition, it is preferable to use aluminum or an aluminum alloy (alloy of aluminum and titanium or molybdenum and the like, for example) for the reflection film 106 configuring the third information recording layer L2 that is the farthest away from the incident face IF. The film thickness of the reflection layer 106 is suitable to be within the range of 20 nm to 35 nm (in the case of single-sided three-layered disc).

It is desirable that a reflectance of a semitransparent film or a reflection film configuring each information recording layer be high, and further, be well balanced. Thus, ideally, the reflectance of each layer is 33%. However, it is unavoidable that a light quantity of about 10% is lost in each layer. Therefore, in the case of a single-sided three-layered optical disc, it is preferable that an upper limit be 23% from (100%−10%×three layers)/three layers=23%.

In addition, if there is no at least reflectance (4%) as high as that of a recording disc, an S/N ratio is short at the side of a recording/reproducing apparatus, and thus, a lower limit of a reflectance becomes 4%. However, it is possible to ensure that the reflectance of each layer is equal to or greater than 10% by employing a material for, and the film thickness of, the above-described information recording layer. As semitransparent films of the first and second layers, an advantageous effect identical to that in the case of using solver or a silver alloy can be attained by using a material (such as SiO₂, ZnS, or dielectric material) having a different refractive index from a refractive index (n=1.62) of the first molding disc 101 or a refractive index (n=1.5) of the first intermediate layer, instead of silver or a silver alloy.

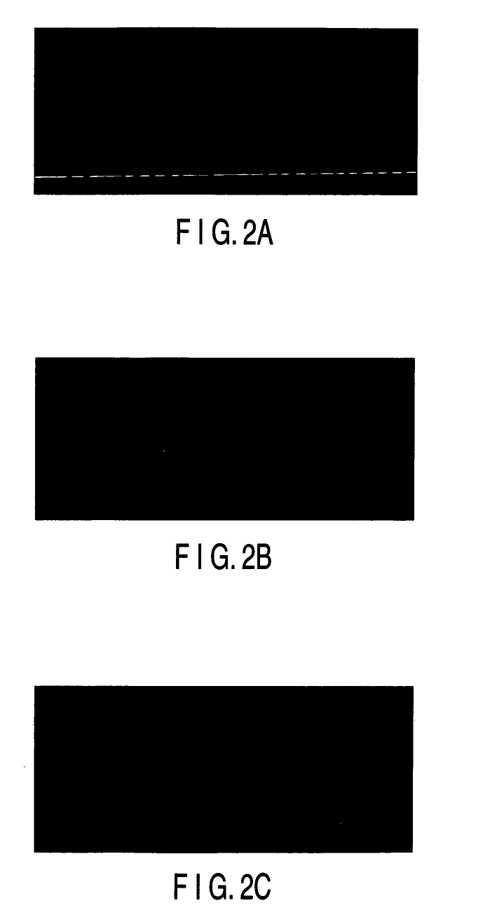

Table 2 and FIGS. 2A to 2C each show a result of actually producing a single-sided three-layered reproduction only optical disc and checking a signal quality with the above-described configuration.

TABLE 2

| | Distance | | | | |
|---|---|---|---|---|---|
| | from | | | | |
| | incident | | | Reflection | Reflec- |
| Layer | face | SbER | PRSNR | film | tance |
| L0 | 0.575 μm | 4.30 × E−06 | 18.7 | Ag alloy | 16.8 |
| | | | | 12 nm | |
| L1 | 0.596 μm | 3.10 × E−05 | 15.9 | Ag alloy | 17.3 |
| | | | | 20 nm | |
| L2 | 0.623 μm | 6.40 × E−06 | 17.6 | Al alloy | 14.3 |
| | | | | 27 nm | |

SbER: Simulated bit Error Rate,
PRSNR: Partial Response Signal Noise Ratio

FIG. 2A shows a reproducing signal waveform from the first information recording layer L0; FIG. 2B shows a reproducing signal waveform from the second information recording layer L1; and FIG. 2C shows a reproducing signal waveform from the third information recording layer L2.

In this manner, it was verified that a single-sided three-layered HD DVD-ROM disc conforming to an HD DVD-ROM standard (SbER≦5.0×10⁻⁵ and PRSNRR≧15) could be produced by producing a disc conforming to a distance up to an information recording layer, intermediate layer thickness, a reflection film material and film thickness thereof, and a reflectance.

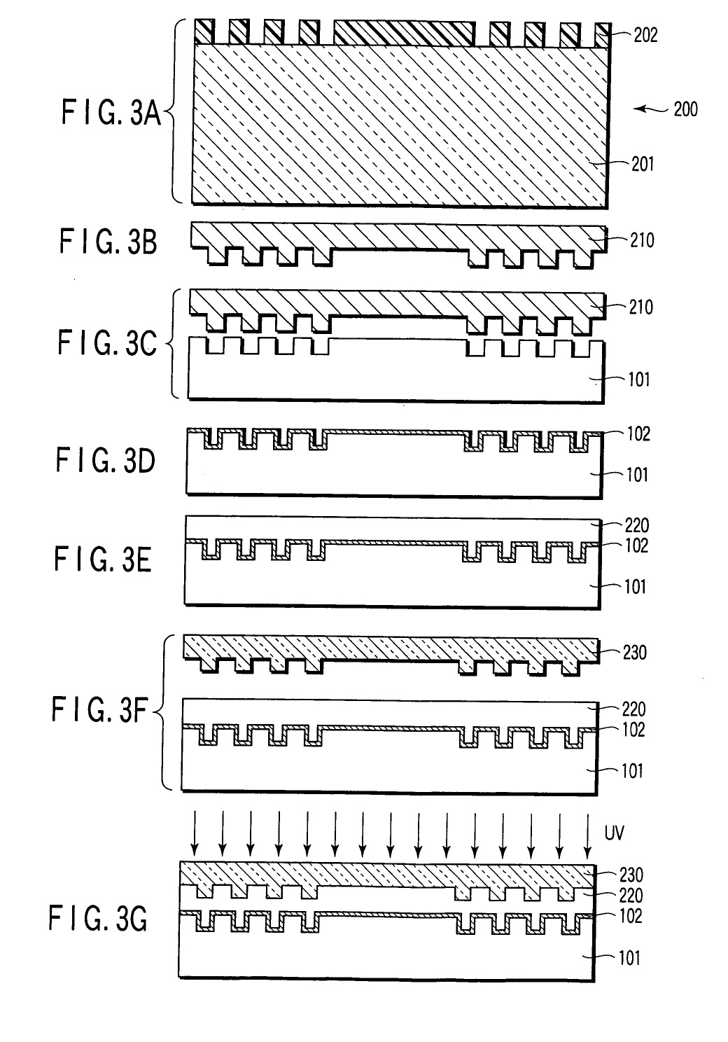

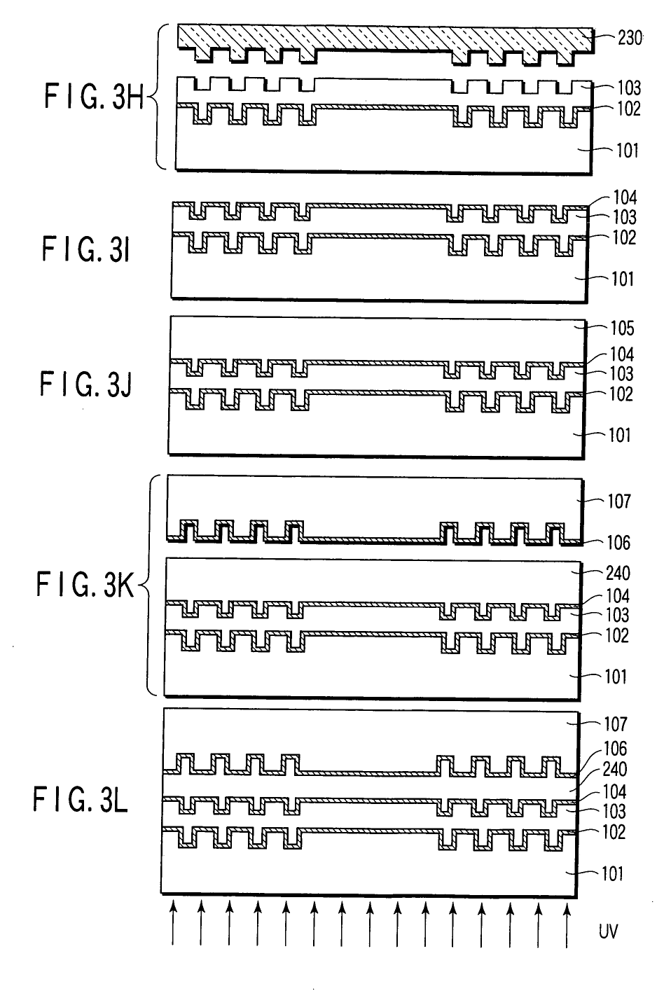

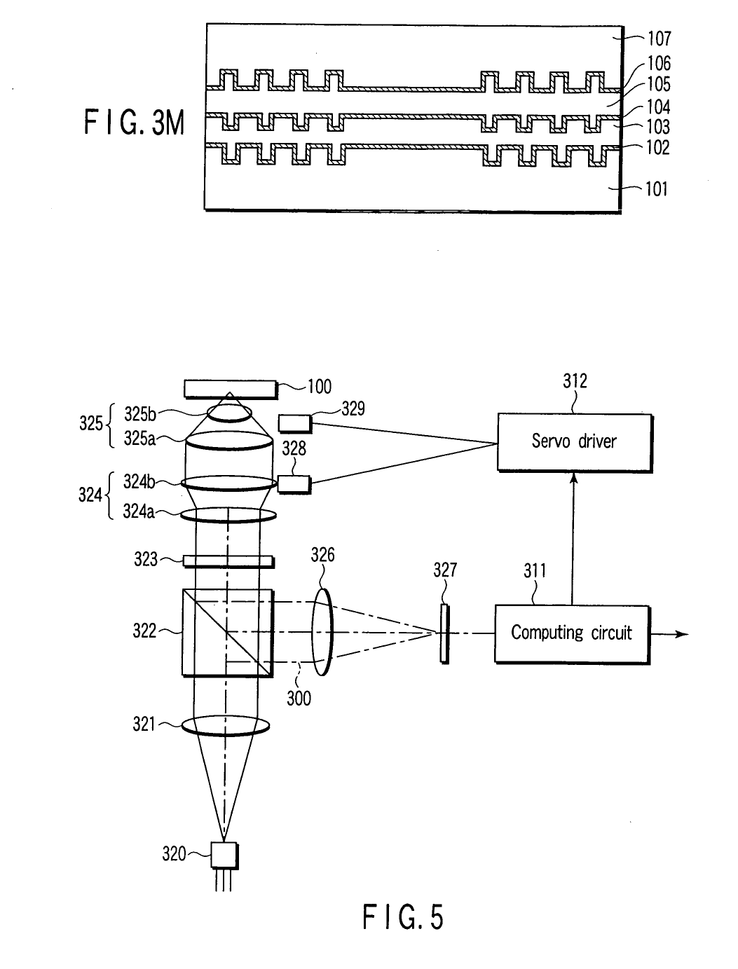

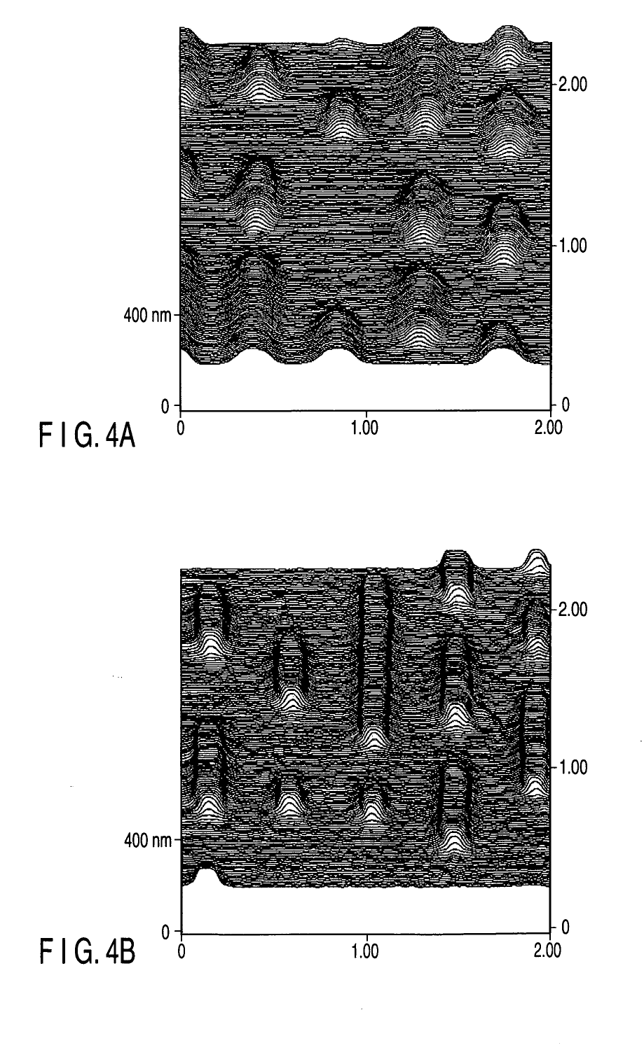

Now, a method for manufacturing a single-sided three-layered optical disc according to an embodiment of the present invention will be described below with reference to FIGS. 3A to 3M. The present embodiment assumes that the disc has a diameter of 120 mm and thickness of 1.2 mm (two bonded polycarbonate molding substrates). However, of course, the disc is not limited to that according to the present embodiment.

First, as shown in FIG. 3A, a master disc 200 of an optical disc is produced. A method for producing the master disc 200 will be described here. A photo resist is applied to a surface of a glass substrate 201 whose surface has been polished and washed, and its surface is exposed and developed with a laser light beam (or an electron beam and the like), thereby forming irregularities of an information pattern. A silicon substrate may be used instead of the glass substrate 201.

As shown in FIG. 3B, a stamper 210 is produced from the master disc 200. As shown in FIG. 3C, a first molding disc 101 is produced, the disc having a first pit in which an information pattern has been transferred by means of injection molding using the stamper 210 for a die. At this time, polycarbonate is generally used as a molding material. However, for example, other plastic materials such as PMMA or cyclo olefin and amorphous polyolefin may be used.

Next, as shown in FIG. 3D, a first semitransparent film 102 is formed in accordance with a sputtering technique on a face having formed thereon a first pit of the first molding disc 101. In the case of the present embodiment, although a silver alloy is used as a composite material for the first semitransparent film 102, other materials such as an organic dye (write-once type optical disc) and an inorganic recording film (phase change film) (rewritable type optical disc) may be used.

As shown in FIG. 3E, a photo polymer (ultraviolet-ray hardening resin) 220 is applied on the first semitransparent film 102. As shown in FIG. 3F, a transparent plastic stamper 230 is prepared for an ultraviolet ray for hardening the photo polymer 220. An information pattern of the second information recording layer L1 is engraved on the plastic stamper 230. Production is carried out in accordance with a method similar to that of the first molding disc 101 described previously, by using polycarbonate for a material (PMMA or cyclo olefin and amorphous polyolefin or the like may be used).

As shown in FIG. 3G, in a state in which the plastic stamper 230 is pressed on the photo polymer 220, an ultraviolet ray UV is irradiated to the photo polymer 220 from the plastic stamper 230. The photo polymer 220 is hardened, whereby a second intermediate layer 104 is formed, the intermediate layer having a second pit to which an information pattern provided at the plastic stamper 230 has been transferred.

As shown in FIG. 3H, after the photo polymer 220 is hardened, and a first intermediate layer 103 is formed, the plastic stamper 230 is released from the first intermediate layer 103. The photo polymer 220 requires performances such as viscosity capable of transferring a pattern formed on the plastic stamper 230, good molding release property with respect to the plastic stamper 230, high transparency with respect to a recording/reproducing light beam, and no corrosion with respect to the first semitransparent film 102 and the second semitransparent film 104.

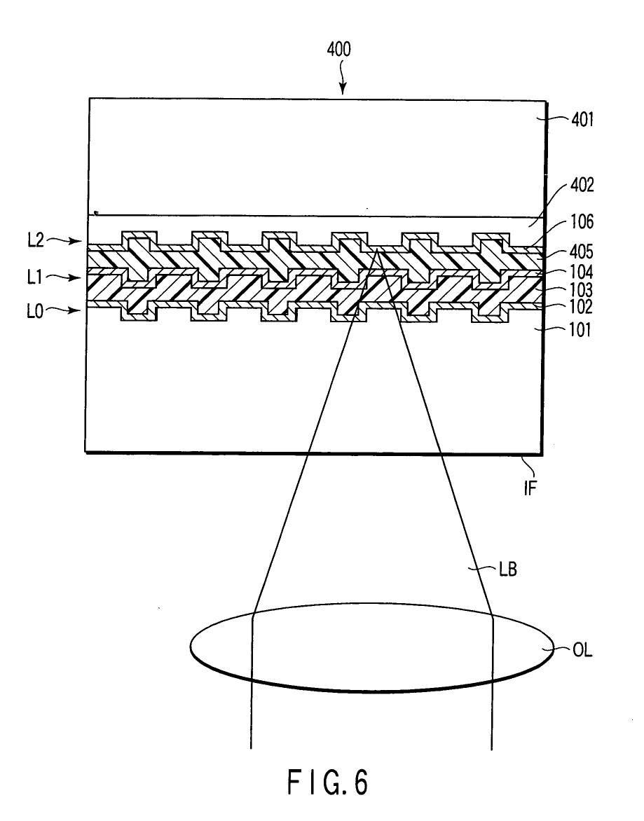

In order to check viscosity capable of transferring the pattern, an optical disc was produced by changing the viscosity of the photo polymer 220 before hardened. In the case where the viscosity of the photo polymer 220 before hardened is 325 cps, a pattern transfer failure occurred as shown in FIG. 6A. In the case where the viscosity of the photo polymer 220 before hardened is 300 cps, a pattern could be normally transferred as shown in FIG. 6B. Therefore, if the viscosity of the photo polymer before hardened is not 300 cps or less, a high density pattern cannot be transferred.

Further, in order to check mold releasing property, a photo polymer 200 having changed a viscoelastic coefficient was prepared, the first intermediate layer 103 was formed by irradiating an ultraviolet ray to the photo polymer 220, and then, it was checked whether or not the plastic stamper 230 is released from the first intermediate layer 103. The check result was shown in Table 3.

TABLE 3

| | Viscoelastic | Use of | Adhesive |
|---|---|---|---|
| | coefficient | plastic | force to |
| | [MPa] | stamper | plastic |
| Photo polymer A | 1100 | Impossible | Large |
| Photo polymer B | 1280 | | |
| Photo polymer C | 1300 | Possible | [symbol] |
| Photo polymer D | 1700 | | |
| Photo polymer E | 1830 | | |
| Photo polymer F | 2360 | | Small |

As shown in Table 3, if the viscoelastic coefficient of the photo polymer 220 is 1300 MPa or more, it was found that an adhesive force to a plastic is comparatively weak, and a plastic stamper can be used.

Next, as shown in FIG. 3I, a second semitransparent film 104 is formed on the first intermediate layer 103. In the case of the present embodiment, a silver alloy is used as a composite material for the second semitransparent film 104, other materials such as an organic dye (write-once type optical disc) and an inorganic recording film (phase change film) (rewritable type optical disc) may be used.

As shown in FIG. 3J, an ultraviolet-ray hardening adhesive 240 is applied onto the second semitransparent film 104.

As shown in FIG. 3K, a second molding disc 107 on which a reflection film 106 is formed is prepared. An information pattern of a third recording information layer is engraved on the second molding disc, polycarbonate is used for a material, and production is carried out in accordance with a method similar to that of the first molding disc 101. PMMA, cyclo olefin and amorphous polyolefin or the like may be used instead of polycarbonate. The reflection film 106 is formed on a face having an information pattern formed thereon. In the case of the present embodiment, although the reflection film 106 is provided as a full reflection film made of an aluminum alloy, other materials such as an organic dye (write-once type optical disc) and an inorganic recording film (phase change film) (rewritable type optical disc) may be used.

As shown in FIG. 5L, in a state in which an information pattern forming face of the second molding disc 107 is pressed against the ultraviolet-ray hardening adhesive 240, an ultraviolet ray UV is irradiated from the first molding disc 101 to the ultraviolet-ray hardening adhesive 240. The ultraviolet-ray hardening adhesive 240 is hardened, whereby a second intermediate layer 105 is formed as shown in FIG. 5M.

Lastly, a single-sided three-layered optical disc is completed by carrying out cutting of a burst cutting area (BCA) or label printing onto the second molding disc 107. In the case of a rewritable type optical disc, it is necessary to carry out initialization of a recording film.

Now, a reproducing apparatus for reproducing information recorded in the optical disc 100 shown in FIG. 1 will be described with reference to FIG. 5. In addition, the reproducing apparatus shown in FIG. 5 can be used as a recording apparatus for recording information in the case where an optical disc is of a write-once type or of a rewritable type.

With respect to a recording/reproducing apparatus for carrying out recording/reproducing operation to a multi-layered optical disc, in addition to a current recording/reproducing apparatus, there is a need for a mechanism for identifying how many layers an inserted optical disc has; a mechanism for carrying out focusing on each of multiple layers; and a mechanism for carrying out recording/reproducing operation for each of the focused information recording layers. In addition, in the case where a standard for an intermediate layer of an optical disc is determined for an optical system without considering a mechanism of spherical aberration correction, there is a need for spherical aberration correction for the optical system.

A semiconductor laser 320 having a short wavelength is used for a light source. A wavelength of its emitted light beam has an ultraviolet-ray wavelength band ranging from 395 nm to 415 nm, for example. Emitted light beams 300 from a semiconductor laser light source 20 are produced as parallel light beams by means of a collimator lens 21, and the parallel light beams pass through a polarizing beam splitter 322 and a λ/4 disc 323. Then, the resulting light beams pass through a relay lens system 324, and then, the beams are incident to an objective lens 325.

Then, the emitted light beams of the objective lens 325 pass through the first molding disc 101 of the optical disc 100, and the resulting beams are focused on any of the information recording layers L0 to L2. A reflection light beam from the information recording layer of the optical disc 100 passes through the fist molding disc 101 of the optical disc 100 again, and passes through the objective lens 325, the relay lens system 324, and the λ/4 disc 323. Then, the resulting light beam is reflected by the polarizing beam splitter 322, after which the light beam passes through a photo detecting system 326, and is incident to an optical detector 327.

A photorecepter section of the photo detector 327 is generally divided into a plurality of sections, and a current according to optical intensity is output from each one of the photoreceptor sections. The outputted current is converted into a voltage by means of an I/V amplifier (not shown), the converted voltage is processed by means of a computing circuit 311, and an HF signal, a focus error signal, and a track error signal or the like are outputted. The focus error signal and track error signal obtained by means of the computing circuit 311 and a tuning signal described later are supplied to a servo driver 312.

The objective lens 325 can move in an optical axis direction, and is used for identification control of the number of information recording layers and for focus control. The movement of the objective lens 325 is controlled by means of a drive section 329. Identification control of the number of layers will be described here. The computing circuit 311 causes the objective lens 325 to move in an optical axis direction by means of the servo driver 312 and the drive section 329. The photo detector 327 detects signal intensity of the reflection light beam 300, and supplies a detection signal to the computing circuit 311. The peak number of the detection signal differs depending on the number of information recording layers provided in the optical disc 100. Therefore, the computing circuit 311 discriminates the number of information recording layers from the number of peaks included in signal intensity.

A publicly known astigmatic technique, a knife edge technique, or a spot size detecting technique and the like is used as a focus error detecting method.

Here, the relay lens system 324 is composed of a bottom lens 324a and a top lens 324b, and the top lens 324b can move in the optical axis direction. The movement of the top lens 324b is carried out by means of a drive section 328.

The relay lens system 324 is designed so that parallel light beams are incident to the objective lens 325 when a distance of the information recording layer from the incident face IF is 600 μm. However, in the case where the information recording layer is multiply layered, there always exists a layer in which the distance from the information recording layer is not 600 μm. Therefore, in the case of the information recording layer in which the distance from the incident face IF is displaced from 600 μm, a spherical aberration occurs. At this time, a focusing spot shape on the information recording layer of the optical disc 100 is distorted, and thus, stable and precise recording/reproducing operation becomes difficult. On the other hand, the light beam incident to the objective lens 325 is produced as a convergent light beam or a divergent light, whereby a spherical aberration occurs. In addition, the top lens 324b of the relay lens system 324 is moved in the optical axis direction, whereby the light beam incident to the objective lens 325 can be produced as a convergent light beam or a divergent light beam.

Thus, the top lens 324b of the relay lens system 324 is moved in the optical axis direction according to a layer of the information recording layer, and the light beam incident to the objective lens 325 is produced as a convergent light beam or a divergent light beam, whereby a spherical aberration caused by a position of the information recording layer can be corrected.

Specifically, in the case where a distance between an irradiation face and the information recording layer is longer than 600 μm in thickness, the top lens 324b of the relay lens system 324 may be moved in the optical axis direction so that the light beam incident to the objective lens 25 is produced as a divergent light beam in accordance with the distance. In addition, in the case where the distance between the irradiation face and the information recording layer is shorter than 600 μm in thickness, the top lens 324b of the relay lens system 324 may be moved in the optical axis direction so that the light beam incident to the objective lens 325 is produced as a convergent light beam in accordance with the distance.

As described above, an optical disc reproducing apparatus comprises means for correcting a spherical aberration caused by a position of the information recording layer of the optical disc 100.

By using the disc structure and disc manufacturing method, material, and recording/reproducing apparatus as described above, a large capacity of an optical disc due to multi-layering of the information recording layer can be achieved while making best use of a disc manufacturing facility or a recording/reproducing optical system of a current optical disc (DVD or HD DVD).

### MODIFIED EXAMPLE

FIG. 6 shows a single-sided three-layered optical disc as a modified example of the above-described optical disc. In this optical disc 400, unlike the optical disc 100 shown in FIG. 1, a third pit indicating information is provided at a photo polymer 405. In addition, a dummy molting disc 401 and a first molding disc 101 are bonded with each other by an ultraviolet-ray hardening type adhesive 402.

The structure of this optical disc 400 is particularly preferable in the case of a write-once type optical disc using an organic dye. In the case of the information recording layer of the write-once type optical disc, an organic dye layer, a reflection layer (or semitransparent layer) and pit indicating information are laminated sequentially from the incident face side. In the write-once type optical disc, an organic dye in a groove pattern causes a chemical change to carry out recording. Therefore, it is preferable that the organic dye layer and the pit be in direct contact with each other without interposing the reflection layer (or semitransparent layer), and thus, the structure of the optical disc 400 is desirable.

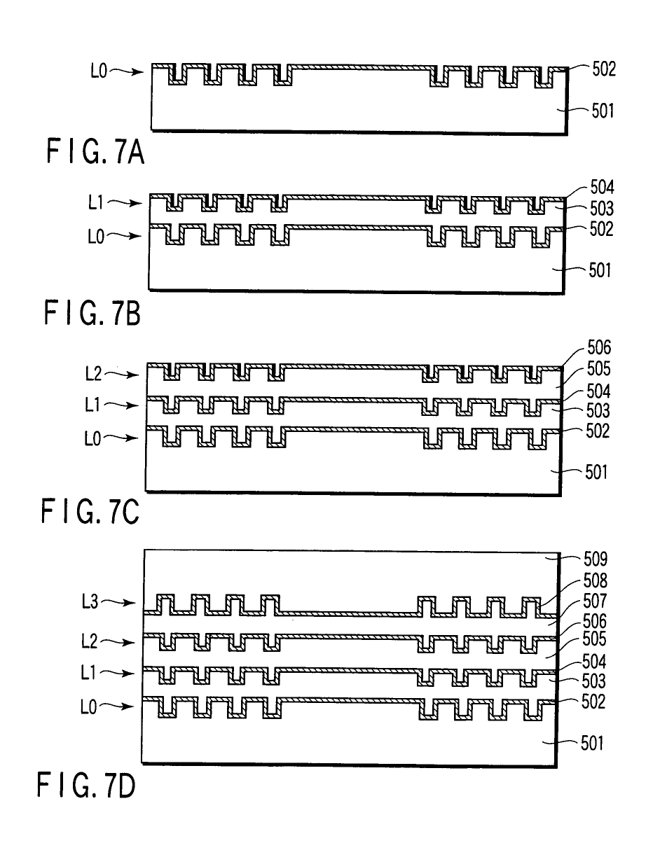

Further, an embodiment of a single-sided four-layered optical disc is shown here. There are two primary methods for manufacturing the single-sided four-layered optical disc. First, one of the methods will be described with reference to FIGS. 7A to 7D.

As shown in FIG. 7A, a first molding disc 501 is prepared, the first molding disc having a first information recording layer L0 which consists of a first pit (irregular pattern) and a first semitransparent film 502. As shown in FIG. 7B, a second intermediate layer 503 and a second semitransparent film 504 composed of a photo polymer are formed on the first semitransparent film 502. Before forming the second semitransparent film 504, a second pit (irregular pattern) is provided at the second intermediate layer 503. A second information recording layer L1 is composed of the second pit and the second semitransparent film 504.

As shown in FIG. 7C, a third intermediate layer 505 and a third semitransparent film 506 composed of a photo polymer are formed on the second semitransparent film 504. Before forming the third semitransparent film 506, a third pit (irregular pattern) is formed on the third intermediate layer 505. A third information recording layer L2 is composed of the third pit and the third semitransparent film 506.

As shown in FIG. 7D, a second molding disc 509 and a first molding disc 501 having a reflection film (fourth information recording layer L3) 508 formed on a pit formed face are bonded with each other by an ultraviolet-ray hardening adhesive 507. Before forming the reflection film 508, a fourth pit (irregular pattern) is formed on the second molding disc 509. The fourth information recording layer L3 is composed of the fourth pit and the reflection film 508.

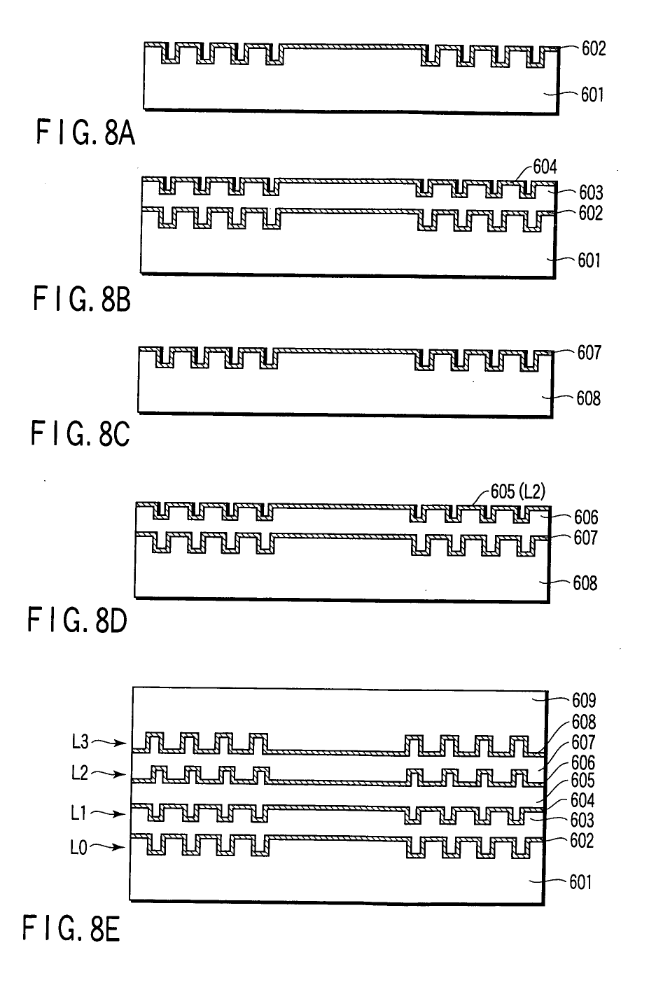

The other one of the manufacturing methods will be described with reference to FIGS. 8A to 8E. As shown in FIG. 8A, a first molding disc 601 is prepared, the first molding disc having a first information recording layer L0 which consists of a first pit (irregular pattern) and a first semitransparent film 602. As shown in FIG. 8B, a second intermediate layer 603 and a second semitransparent film 604 composed of a photo polymer is formed on the first semitransparent film 602. Before forming the second semitransparent film 604, a second pit (irregular pattern) is formed on a surface of the second intermediate layer 603. A second information recording layer L1 is composed of the second pit and the second semitransparent film 604.

As shown in FIG. 8C, a second molding disc 609 is prepared, the second molding disc 609 having a fourth information recording layer L3 that consists of a fourth pit (irregular pattern) and a reflection film 608. As shown in FIG. 8D, a third intermediate layer 607 and a third semitransparent film (third information recording layer L2) 606 composed of a photo polymer is formed on the reflection film 608. Before forming the third semitransparent film 606, a third pit (irregular pattern) is formed on a surface of the third intermediate layer 607. The third information recording layer L2 is composed of the third pit and third semitransparent film 606.

As shown in FIG. 8E, a first molding disc 601 having a first information recording layer 611 and a second information recording layer 612 is bonded with a second molding disc 609 having a fourth information recording layer 614 and a third information recording layer 613 by means of an ultraviolet-ray hardening adhesive 605, whereby a single-sided four-layered optical disc is produced.

In these single-sided four-layered optical disc as well, there are several types such as a reproduction only type, a write-once type, and a rewritable type, and of course, multi-layering can be further carried out by using a similar method.

By using the disc structure and disc manufacturing method as described above, a large capacity of an optical disc due to multi-layering of an information recording layer can be achieved while making best use of a disc manufacturing facility or a recording/reproducing optical system of a current optical disc (DVD or HD DVD).

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An optical disc comprising:
a first molding disc having an incident face;
a second molding disc arranged to face the first molding disc; and
three or more of a predetermined number of information recording layers between the first molding disc and the second molding disc, a distance between the incident face and each of the information recording layers is within the range of 600±55 μm.

2. The optical disc according to claim 1, comprising:
a first information recording layer provided on a surface of the first molding disc opposite to the incident face; and
a second information recording layer provided on a surface of the second molding disc at the incident face side,
wherein an information recording layer other than the first information recording layer and the second information recording layer has an irregular pattern provided at an ultraviolet-ray hardening resin.

3. The optical disc according to claim 2, wherein a viscoelastic coefficient of the ultraviolet-ray hardening resin is 130 MPs or more.

4. The optical disc according to claim 2, wherein viscosity obtained before hardening the ultraviolet-ray hardening resin is 300 cps or less.

5. The optical disc according to claim 1, comprising a first information recording layer provided on a surface of the first molding disc opposite to the incident face,
wherein an information recording layer other than the first information recording layer has an irregular pattern provided at an ultraviolet-ray hardening resin.

6. The optical disc according to claim 5, wherein a viscoelastic coefficient of the ultraviolet-ray hardening resin is 130 MPs or more.

7. The optical disc according to claim 5, wherein viscosity obtained before hardening the ultraviolet-ray hardening resin is 300 cps or less.

8. The optical disc according to claim 1, wherein an intermediate layer is provided between a pair of information recording layers adjacent to each other in a thickness direction, and thickness of the intermediate layer is 15 μm or more and 55 μm or less.

9. The optical disc according to claim 1, comprising a first information recording layer composed of aluminum or an aluminum alloy and provided on a surface of the first molding disc opposite to the incident face,
wherein an information recording layer other than the first information recording layer is composed of silver or a silver alloy.

10. The optical disc according to claim 1,
wherein the predetermined number of layers is three,
there are provided a first information recording layer having a first semitransparent film, a second information recording layer having a second semitransparent film, and a third information recording layer having a reflection film from the incident face side,
the first semitransparent film is composed of silver or a silver alloy having thickness of 7 nm to 15 nm,
the second semitransparent film is composed of silver or a silver alloy having thickness of 13 nm to 22 nm, and
the reflection film is composed of aluminum or an aluminum alloy having thickness of 20 nm to 35 nm.

11. The optical disc according to claim 1, wherein the predetermined number of layers is three, there are provided a first information recording layer, a second information recording layer, and a third information recording layer from the incident face side, and
reflectances of the first to third information recording layers with respect to a wavelength of a laser light beam to reproduce information recorded in the information recording layers are within the range of 4% to 33%.

12. A method for reproducing information of an optical disc having a first molding disc having an incident face, a second molding disc, and three or more information recording layers provided within the range of 600±55 μm from the incident face, the method comprising:
reproducing information recorded in any one of the three or more information recording layers by irradiating a laser light beam to the incident face.

13. The information recording apparatus according to claim 12, wherein the optical system irradiates to the irradiation face a laser light beam having a wavelength ranging from 395 nm to 415 nm, and NA=0.65.

14. A method for recording information in an optical disc having a first molding disc having an incident face, a second molding disc, and three or more information recording layers provided within the range of 600±55 μm from the incident face, the method comprising:
recording information in any one of the three or more information recording layers by irradiating a laser light beam to the incident face.
